(19) United States
(12) Patent Application Publication
(10) Pub. No.: US 2025/0040743 A1
(43) Pub. Date: Feb. 6, 2025

(54) EASILY-CLEANED RICE COOKER

(71) Applicant: JOYOUNG COMPANY LIMITED, Jinan (CN)

(72) Inventors: Zechun ZHU, Jinan (CN); Yang LI, Jinan (CN); Lingzhen YU, Jinan (CN); Tao WANG, Jinan (CN)

(21) Appl. No.: 18/716,927

(22) PCT Filed: Nov. 23, 2022
(86) PCT No.: PCT/CN2022/133703

§ 371 Date: Jun. 5, 2024

(30) Foreign Application Priority Data
Dec. 6, 2021 (CN) 202111472568.X
Dec. 6, 2021 (CN) 202111511407.7
Dec. 6, 2021 (CN) 202123033724.0
Dec. 6, 2021 (CN) 202211314733.3

(51) Int. Cl. A47J 27/00

(52) U.S. Cl. CPC A47J 27/002; A47J 27/004

(57) ABSTRACT

Disclosed is an easily-cleaned rice cooker, comprising a cooker main body (10), a cooker lid (20), an inner container (30) used for cooking rice, a heating device (105) and a cooling fan (40). The cooker main body is provided with an accommodation cavity (106). The inner container (30) is arranged in the accommodation cavity (106) and located on the heating device (105). The cooker lid (20) is fitted to seal the accommodation cavity (106) and form a cooking cavity (301) with the inner container (30). The cooker main body (10) comprises a heat preservation inner cover (101) provided with an air inlet (108). The cooling fan (40) is arranged at the air inlet (108). A heat preservation gap (107) is formed between the outer side wall of the inner container and the inner wall of the heat preservation inner cover (101). The air inlet (108) is provided with an air inlet angle facing an inner container lower part (302) and used for reducing the wind resistance of cold air entering the heat preservation gap (107). Cold air entering from the air inlet (108) circularly cools the inner container lower part (302) from bottom to top around the inner container (30). The part of the inner container lower part (302) in contact with rice is cooled. Water vapor in the rice is condensed at the inner walls of the lower part (302) of the inner container (30) in contact with rice to form condensed water, and the condensed water infiltrates the rice attached to the inner walls of the inner container (30). The rice cooker is coating-free, has a good non-stick effect, and is convenient to clean.

The present application is a National Phase entry of PCT Application No. PCT/CN2022/133703, filed on Nov. 23, 2022, which claims the priorities to following Chinese Patent Applications:
1) Chinese Patent Application No. 202111472568.X, titled “EASY-TO-CLEAN RICE COOKER”, filed with the China National Intellectual Property Administration on Dec. 6, 2021;
2) Chinese Patent Application No. 202111511407.7, titled “EASY-TO-CLEAN”, filed with the China National Intellectual Property Administration on Dec. 6, 2021;
3) Chinese Patent Application No. 202123033724.0, titled “EASY-TO-CLEAN”, filed with the China National Intellectual Property Administration on Dec. 6, 2021;
4) Chinese Patent Application No. 202211314733.3, titled “EASY-TO-CLEAN”, filed with the China National Intellectual Property Administration on Dec. 6, 2021; and the entire disclosures of which are incorporated herein by reference.

### FIELD

The present application relates to the field of kitchen appliance, and in particular to an easy-to-clean rice cooker.

### BACKGROUND

An existing rice cooker has a non-stick coating on an inner surface of an inner cooking container to prevent rice from sticking to it. However, the non-stick coating has a limited service life in use. It may easily peel off when being at a high temperature or being scraped, hence the non-stick performance on the inner cooking container cannot last for a long time. Furthermore, the coating, which has peeled off, may be easily mixed into the rice and eaten by a user, which affects the health of the user. After the coating peels off, a base of the inner cooking container is directly exposed to an environment with high temperature and humidity during cooking, which affects food safety. Therefore, the inner cooking container cannot be used after the coating peels off. If the inner cooking container is made without coating (the inner surface of the inner cooking container is made of stainless steels, for example), the rice may easily stick to the inner cooking container and can hardly be scooped out by a spoon.

Some current rice cookers prevent the rice from sticking by cooling the inner cooking container instead of having coating thereon. However, they have a poor non-stick performance due to an uneven cooling, and the rice still sticks to the pot to some extent.

### SUMMARY

An easy-to-clean rice cooker is provided according to the present application to solve the problem that a rice cooker has a poor non-stick performance without coating.

Embodiments are provided according to the present application as follows.

An easy-to-clean rice cooker includes a cooker body, a cooker lid, an inner cooking container configured for cooking rice, a heating device, and a cooling fan. The cooker body is provided with an accommodation chamber, and the inner cooking container is arranged inside the accommodation chamber and is located above the heating device, when the cooker lid is closed, the accommodation chamber is enclosed and a cooking chamber is formed by the cooker lid and the inner cooking container, a part of a lower portion of the inner cooking container that contacts the rice is cooled, and condensed water is formed at the part of the lower portion of the inner cooking container, and wets the rice contacting an inner wall of the inner cooking container, a first air outlet is provided at a position where the cooker lid and the cooker body are combined, a combination gap is provided between the cooker lid and the cooker body, and the combination gap forms the first air outlet; and cool air is discharged through the first air outlet after cooling the inner cooking container.

With the above embodiment, the present application has the following effects.

Since the air is discharged through the first air outlet, airflow from bottom to top is easily formed, which improves the cooling effect on the inner cooking container, to achieve the non-stick performance.

### BRIEF DESCRIPTION OF THE DRAWINGS

The accompanying drawings described herein are intended to provide a further understanding of the present application, and constitute a part of the present application. Illustrative embodiments of the present application and the description thereof are for explaining the present application, and do not constitute an undue limitation of the present application.

FIG. 1 is a sectional view of a rice cooker according to an embodiment of the present application;

FIG. 2 is a view of the rice cooker according to the embodiment of the present application when a cooker lid is open:

FIG. 3 is a schematic partial view showing a part of a lower portion of an inner cooking container according to the embodiment of the present application that contacts rice:

FIG. 4 is a schematic partial view showing a position where the cooker lid and a cooker body according to the embodiment of the present application are combined:

FIG. 5 is a schematic view of a second air outlet according to an embodiment of the present application:

FIG. 6 is a schematic view of an inner cooking container according to the embodiment of the present application:

FIG. 7 is a schematic view of an inner cooking container having a spherical inner wall according to an embodiment of the present application:

FIG. 8 is a schematic view of an inner cooking container having a groove according to an embodiment of the present application:

FIG. 9 is a partially enlarged schematic view of a cooling fan on an thermal insulation inner cover according to the embodiment of the present application:

FIG. 10 is a schematic view of the cooling fan according to the embodiment of the present application:

FIG. 11 is a sectional view of a rice cooker according to a second embodiment of the present application:

FIG. 12 is a partially enlarged view of FIG. 11:

FIG. 13 is a perspective view of the rice cooker according to the second embodiment of the present application;

FIG. 14 is a first schematic view of a heating plate according to the second embodiment of the present application; and

FIG. 15 is a second schematic view of the heating plate according to the second embodiment of the present application.

Reference numerals:

| | | | |
|---|---|---|---|
| 10 | cooker body, | 101 | thermal insulation inner cover, |
| 102 | outer housing, | 103 | base, |
| 104 | ring, | 105 | heating device, |
| 106 | accommodation chamber, | 107 | thermal insulation gap, |
| 108 | air inlet, | 109 | air suction port, |
| 110 | first air outlet, | 111 | bottom gap, |
| 112 | air outlet channel, | 113 | second air outlet, |
| 114 | inner cavity, | 115 | support member, |
| 20 | cooker lid, | 30 | inner cooking container, |
| 301 | cooking chamber, | | |
| 302 | lower portion of inner | | |
| | cooking container, | | |
| 303 | waist portion of inner | | |
| | cooking container, | | |
| 304 | upper portion of inner | | |
| | cooking container, | | |
| 305 | flange of inner cooking | | |
| | container, | | |
| 306 | curved side wall, | | |
| 307 | flat bottom wall, | 308 | spherical inner wall, |
| 309 | groove, | 310 | flat bottom portion, |
| 40 | cooling fan, | 41 | air guide blade, |
| 42 | air guide channel, | 43 | air guide face, |
| 44 | upper air guide blade, | 45 | lower air guide blade, |
| 46 | air guide gap, | 421 | first air guide channel, |
| 422 | second air guide channel, | 50 | rice, |
| 60 | condensed water. | | |

Reference numerals in FIGS. 11 to 15:

| | | | |
|---|---|---|---|
| 1 | cooker body, | 11 | housing, |
| 12 | insulation cover, | 13 | cooling air inlet, |
| 14 | air intake, | 2 | heating plate, |
| 21 | through hole, | 22 | terminal, |
| 23 | rib, | 24 | air deflector, |
| 3 | inner cooking container, | 4 | cooling fan, |
| 5 | first gap, | 6 | second gap, |
| 7 | ventilation gap, | 8 | air channel. |

### DETAILED DESCRIPTION OF THE EMBODIMENTS

In order to illustrate the overall concept of the present application more clearly, embodiments are described in detail in conjunction with the accompanying drawings.

Numerous specific details are described hereinafter for thorough understanding of the present application. However, the present application can also be implemented in other ways different from those described herein. Therefore, the protection scope of the present application is not limited by the specific embodiments disclosed hereinafter.

In addition, in the description of the present application, it should be understood that the orientation or positional relationship indicated by the terms “inner”, “outer”, etc. are based on those shown in the accompanying drawings, and are merely for the convenience of describing the present application and simplifying the description. It does not indicate or imply that the apparatus or element referred to must have a specific orientation, or be constructed and operated in a specific orientation, and therefore should be understood as a limitation to the present application.

In the present application, unless otherwise clearly stated and limited, the terms “mount”, “communicate”, “connect”, “fix” and the like should be interpreted broadly. For example, a connection may be a fixed connection or a detachable connection, or a connection in an integral manner. The connection may be a mechanical connection, an electrical connection, or communication. The connection may be a direct connection, or an indirect connection via an intermediate medium, or internal communication between two elements, or an interaction between two elements. The specific meanings of the above terms in the present application can be understood in the art according to specific circumstances.

In the present application, unless otherwise clearly stated and limited, a first feature is “above” or “below” a second feature may means that, the first feature directly contacts the second feature or indirectly contacts the second feature via an intermediate medium. In the description of this specification, descriptions referring to the terms “solution”, “embodiment”. “one embodiment”, “example”, “specific example”, etc., mean that specific features, structures, materials or characteristics described in connection with the embodiment or example are included in at least one embodiment of the present application. In this specification, schematic expressions of the above terms do not necessarily refer to the same embodiment or example. Furthermore, the specific features, structures, materials or characteristics described may be combined in any suitable manner in any one or more embodiments or examples.

### First Embodiment

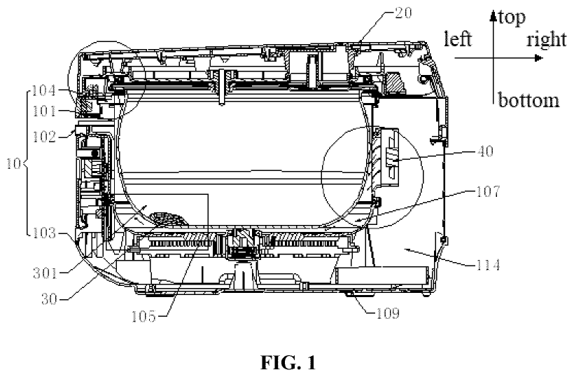

As shown in FIGS. 1 to 3, an easy-to-clean rice cooker includes a cooker body 10, a cooker lid 20, an inner cooking container 30 for cooking rice, a heating device 105, and a cooling fan 40. The cooker body 10 is provided with an accommodation chamber 106, and the inner cooking container 30 is arranged inside the accommodation chamber 106 and is located above the heating device 105. When the cooker lid 20 is closed, the accommodation chamber 106 is enclosed and a cooking chamber 301 is formed by the cooker lid 20 and the inner cooking container 30. The cooker body 10 includes a thermal insulation inner cover 101 having an air inlet 108, and the cooling fan 40 is arranged at the air inlet 108. A thermal insulation gap 107 is provided between an outer side wall of the inner cooking container 30 and an inner wall of the thermal insulation inner cover 101. The air inlet 108 has an air intake angle facing a lower portion 302 of the inner cooking container 30 to reduce an air resistance when cool air enters the thermal insulation gap 107. The cool air enters through the air inlet 108 and circles around the inner cooking container 30 from bottom to top to cool the lower portion 302 of the inner cooking container 30. A part of the lower portion 302 of the inner cooking container 30 contacting the rice 50 is cooled and the temperature thereof is decreased, and water vapor in the rice 50 condenses on an inner wall of the part of the lower portion 302 of the inner cooking container 30 contacting the rice 50 and form condensed water 60. The condensed water 60 wets the rice 50 sticking to the inner wall of the inner cooking container 30.

It should be noted that, the cooker lid 20 and the cooker body 10 may be connected by a hinge, or may arranged separately. By opening or closing the cooker lid 20, a user can 10) take out or put back the inner cooking container 30 which is for cooking the rice, or take out the rice. The inner cooking container 30 is removably arranged inside the accommodation chamber 106 of the cooker body 10, and is heated by the heating device 105 at the bottom. In the present embodiment, the heating device 105 is an electromagnetic coil, which generates an alternating magnetic field to heat the inner cooking container 30 when being powered. The accommodation chamber 106 for accommodating the inner cooking container 30 is formed inside the thermal insulation inner cover 101, and the heating device 105 is fixed at a bottom portion of the thermal insulation inner cover 101. In the case that the heating device 105 is an electromagnetic coil, a bottom side of the thermal insulation inner cover 101 is provided with a bottom opening, and the electromagnetic coil is connected at the bottom opening, and the electromagnetic coil is directly connected to the thermal insulation inner cover 101. The accommodation chamber 106 is enclosed by the thermal insulation inner cover 101 and the electromagnetic coil. After the cooker lid 20 is closed, the accommodation chamber 106 is not in communication with an external space except a position where the cooker lid 20 and the cooker body 10 are combined, a temperature detection hole and a water outlet hole at the bottom. Thus, the accommodation chamber 106 is relatively enclosed. If the heating device 105 is a heating plate, the accommodation chamber 106 is provided with more openings at the bottom, such as an avoidance hole for terminals to extend out of the thermal insulation inner cover 101 and the like.

The cooker body 10 further includes a ring 104, an outer housing 102 and a base 103. The outer housing 102 is arranged outside the thermal insulation inner cover 101. For fixing the thermal insulation inner cover 101 and the outer housing 102, the ring 104 is connected to the base 103, the outer housing 102 is arranged between the ring 104 and the base 103, and the thermal insulation inner cover 101 is arranged on the ring 104. An inner cavity 114 is provided between the outer housing 102 and the thermal insulation inner cover 101. In the case that the heating device 105 is an electromagnetic coil, the base 103 is provided with an air suction port 109. The cooling fan 40 sucks air from the air suction port 109 on the base 103. In some embodiments, the air suction port 109 is provided on the outer housing 102 at a height in correspondence to the air inlet 108.

As shown in FIG. 6, the inner cooking container 30 includes a waist portion 303, the lower portion 302 and an upper portion 304. A diameter of the waist portion 303 is larger than a diameter of the lower portion 302. In some embodiments, the diameter of the waist portion 303 is larger than a diameter of the upper portion 304 as well. The lower portion 302 includes a curved side wall 306 and a flat bottom wall 307. The specific shape of the inner cooking container 30 is described in detail hereinafter.

Since no cooling is performed, there is no temperature difference between an interior and an exterior of a conventional inner cooking container. Sometimes, the temperature of the inner cooking container acting as a heat source is even higher than the temperature of the rice. Therefore, the condensed water cannot form at the inner wall of the part of the lower portion 302 contacting the rice. As a result, the rice browns and sticks to the pot, and in this case, the inner cooking container is hard to clean if no non-stick coating is provided. In the present embodiment, the inner cooking container is cooled by the cooling fan 40, which is described in detail as follows.

Referring to FIG. 1, if the cooling fan 40 is operated, cool air is sucked from the air inlet 108 and blows into the accommodation chamber 106. There is an angle between an air outtake direction of the air inlet 108 and a vertical direction of the cooker body 10, and the air inlet 108 has an air intake angle facing the lower portion 302 to reduce an air resistance when the cool air enters the thermal insulation gap 107. The cool air enters the thermal insulation gap 107 along the air intake angle, and circles around the inner cooking container from top to bottom to cool the lower portion 302. When there is cooked rice inside the inner cooking container 30, high temperature water vapor in the rice condenses on the inner wall of the part of the lower portion 302 contacting the rice. The condensed water wets the rice sticking to the inner wall of the inner cooking container. After cooling, there is a temperature difference between the interior and the exterior of the inner cooking container 30. The temperature is low outside and high inside the inner cooking container 30, i.e. the temperature gradually increases from outside to inside. Therefore, condensed water is continuously formed at the inner wall of the part contacting the rice to wet the rice. In this way, the rice is prevented from sticking, to facilitate cleaning.

When the water condenses, airflow from the existing cooling fan 40 acts unevenly on the lower portion 302, thus the condensed water is not formed at the inner walls of all parts that contact the rice, resulting in a poor non-stick performance.

With an air intake angle, the air resistance when the air enters the thermal insulation gap 107 is decreased, and the air intake amount is increased. Besides, the cool air cools the lower portion 302 at first, and circles around the inner cooking container from bottom to top to cool the lower portion 302. That is, the cool air first blows downwards from the waist portion 303 to the lower portion 302. Along a vertical direction, the diameter of the inner cooking container is usually large at the waist portion 303, and decreases downwards. Therefore, a surface area of the airflow decreases as the airflow moves downwards and close to a bottom of the inner cooking container 30, and increases as the airflow moves upwards and away from the bottom of the inner cooking container 30. Along a horizontal direction, due to the cylinder shape, a curve of the inner cooking container 30 gets larger from a left side to a center line of the inner cooking container 30, and gets smaller from the center line to a right side of the inner cooking container 30. When moving along a left-right direction, a surface area of the airflow flowing from the air inlet 108 increases as the airflow moves close to the center line of the inner cooking container 30, and decreases as the airflow crosses and moves away from the center line of the inner cooking container 30. With an air intake angle, the cool air first flows downwards and then flows upwards to circle around the lower portion 302, and the air flows mainly along the vertical direction rather than the horizontal direction. When moving downwards, the airflow from the air inlet 108 converges, since the surface area gradually decreases. When moving upwards, the airflow disperses, since the surface area gradually increases. When converging, the cool air first has a larger contact area, and then has a small contact area with the inner cooking container 30. In this way, when the air is cool, the air absorbs a lot of heat because of the larger contact area, and the air absorbs less heat after converging, at which time the air is warmer and the contact area is small, to prevent a problem that, condensed water is unevenly formed at each part contacting the rice because the cool air is cold and absorbs too much heat at the small contact area where the air converges. After converging, the cool air has become warmer, and will not absorb much heat at the small contact area when dispersing and moving upwards, thus will not cause uneven cooling.

As shown in FIG. 4, to form the airflow from bottom to top, a first air outlet 110 is provided at the position where the cooker lid 20 and the cooker body 10 is combined. A combination gap is provided between the cooker lid 20 and the cooker body 10, and the combination gap forms the first air outlet 110. The cool air is discharged through the first air outlet 110 after cooling the inner cooking container 30. The air is discharged through the first air outlet 110, which means that, it is better to seal a bottom and a side wall of the accommodation chamber 106 and reduce holes to prevent the air from flowing out of the bottom and the side wall. In one embodiment, the heating device 105 in this case is the above electromagnetic coil which is mounted at the bottom opening of the thermal insulation inner cover 101.

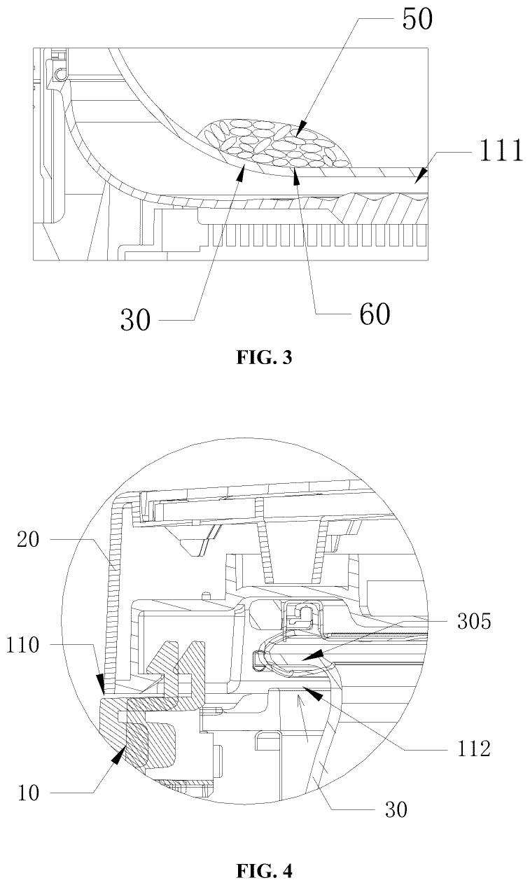

In the present embodiment, as shown in FIG. 3, the inner cooking container 30 is arranged inside the accommodation chamber 106 of the cooker body 10, and the heating device 105 is provided at a lower side of the thermal insulation inner cover 101. A bottom gap 111 is provided between the heating device 105 and the inner cooking container 30. To form the bottom gap 111, the inner cooking container 30 is provided with a flange 305. An air outlet channel 112 is provided at a position where the flange 305 matches the cooker body 10, and the air in the thermal insulation gap 107 enters the first air outlet 110 through the air outlet channel 112. With the air outlet channel 112, the airflow turns its direction when blocked by the flange 305, and the hot air can enter the first air outlet 110 and be discharged more easily.

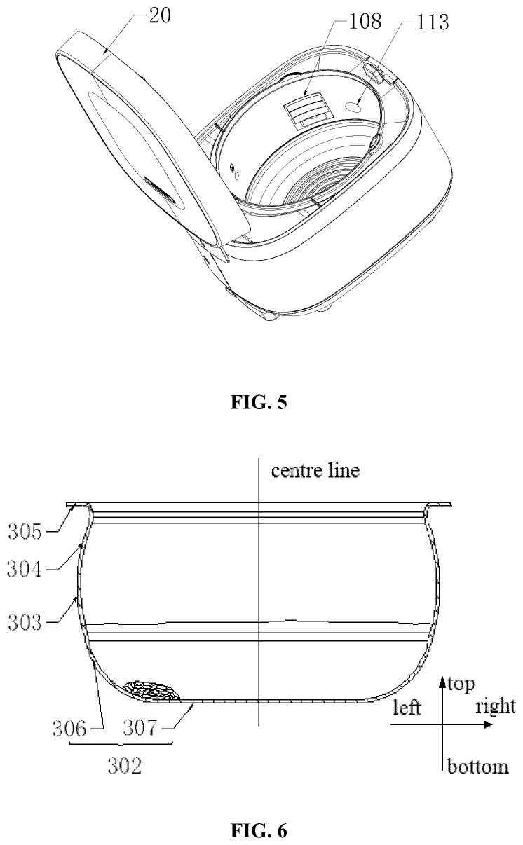

In some variations of the present embodiment, as shown in FIG. 5, a second air outlet 113 is provided at a side of the cooling fan 40, and the second air outlet 113 is in communication with the inner cavity 114 between the thermal insulation inner cover 101 and the outer housing 102. A bottom portion of the cooker body 10 is provided with a heat dissipation hole in communication with the inner cavity 114. The cool air is discharged into the inner cavity 114 through the second air outlet 113 after cooling the inner cooking container 30, and is discharged through the heat dissipation hole.

The term “side” refers to a position that is close to the cooling fan 40 and is at most 10 cm away from the cooling fan 40. The second air outlet 113 may be at a same height as the cooling fan 40. In one embodiment, the second air outlet 113 may be located at other positions in some specific embodiments.

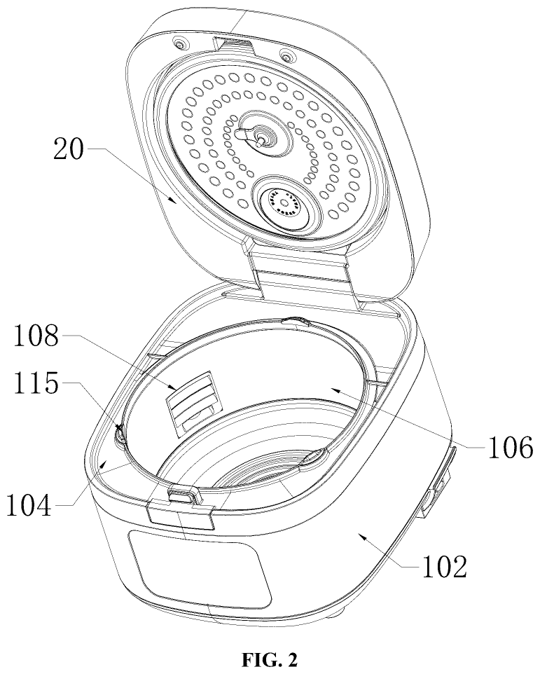

As shown in FIG. 2 and FIG. 4, the ring 104 is provided with a support member 115, which is provided at the position where the flange 305 matches the cooker body 10. The inner cooking container 30 is supported by the support member 115 to form the air outlet channel 112. Multiple support members 115 may be provided. The air outlet channel 112 is formed between adjacent support members 115. In this way, the inner cooking container 30 can be easily hanged on the ring 104 and multiple air outlet channels 112 are formed by the support members 115, and not only an isolation gap but also the air outlet channels 112 can be formed, while the structure is simple.

It takes time for the water to condense, and the cooling time should not be too long. A solution for reducing the cooling time is to reduce the surface area of the part of the lower portion 302 contacting the rice as much as possible, to reduce the power needed for forming the condensed water used to wet the rice.

Estimations and analysis on the process of the forming of the condensed water are provided. At the end of cooking, a temperature of the inner cooking container 30 is about 100° C. to 110° C., and a temperature of the rice is about 100° C. According to the estimations, a sum of a heat released by the inner cooking container 30 when being cooled and a heat released by the water vapor when condensing is equal to a heat taken away by the air from the cooling fan 40.

For example, the cooling fan 40 supplies cool air at a rate of 150 L/min, and the temperature of the inner cooking container is decreased to 95° C. Suppose ΔT_{inner cooking container} is 15° C., and the temperature increase of the cool air is ΔTₐᵢᵣ is 30° C.

The heat released by the inner cooking container when being cooled is Q_{inner cooking container}=m_{inner cooking container}c_{inner cooking container}ΔT_{inner cooking container}.

The heat released by the water vapor when condensing is Q_{water}=m_{water} ΔH_{water}.

The heat taken away by the cool air per minute is Qₐᵢᵣ=mₐᵢᵣcₐᵢᵣΔTₐᵢᵣ.

The time for the condensed water to form is (Q_{inner cooking container}+Q_{water})/Qₐᵢᵣ.

Relative parameters and values are shown in the following table.

| | | | |
|---|---|---|---|
| Temperature of the | 95 | Thickness of the condensed | 0.0002 |
| cooled inner cooking | | water layer (m) | |
| container (° C.) | | | |
| Temperature of the | 100-110 | Area (m\hat{ }2) | 0.03 |
| inner cooking | | | |
| container (° C.) | | | |
| Temperature of the | 100 | Density of the condensed | 1000 |
| rice (° C.) | | water layer (kg/m\hat{ }3) | |
| Mass of the inner | 0.8 | Heat of coagulation of the | 2271 |
| cooking container | | water vapor ΔH_{water} (kJ/kg) | |
| m_{inner cooking container} | | | |
| (kg) | | | |
| Specific heat capacity | 550 | Mass of the condensed | 0.006 |
| of the inner cooking | | water m_{water} (kg) | |
| container | | | |
| c_{inner cooking container} | | | |
| (J /(kg · ° C.)) | | | |
| Flow rate of the cool | 150 | | |
| air (L/min) | | | |
| Specific heat capacity | 1005 | Heat released by the inner cooking | 6600 |
| of the air cₐᵢᵣ | | container when being cooled | |
| (J/(kg · ° C.)) | | Q_{inner cooking container} (J) | |
| Temperature increase | 30 | Heat released by the water | 13626 |
| of the cool air (° C.) | | vapor when condensing Q_{water} (J) | |
| Density of the cool | 1.146 | Heat taken away by the cool | 5182.785 |
| air (kg/m\hat{ }3) | | air per minute Qₐᵢᵣ (J) | |
| mₐᵢᵣ Mass of the air | 0.1719 | Cooling time (min) | 3.902535027 |
| (kg) | | | |

According to the estimations above, the condensed water layer can be formed within 4 minutes. Adding 4 minutes is acceptable for rice cooking, which can be added to the entire rice cooking process. A small cooling fan with a diameter of around 50 mm is enough for supplying airflow at a flow rate of 150 L/min, hence this solution has a good feasibility.

As verified by tests on a sample cooker, the cooling fan 40 can decrease the temperature of the inner surface of the inner cooking container to 95° C. within 3 to 5 minutes. A condensed water layer is formed on the surface of the inner wall of the inner cooking container, which prevents the rice from sticking to the inner cooking container.

It can be seen from the above calculations that, the area of the condensed water layer, the specific heat capacity and the mass of the inner cooking container, and the temperature increase of the cool air are affected by the material, the shape and the weight of the inner cooking container. Therefore, the cooling time can be controlled by modification of the structure of the inner cooking container.

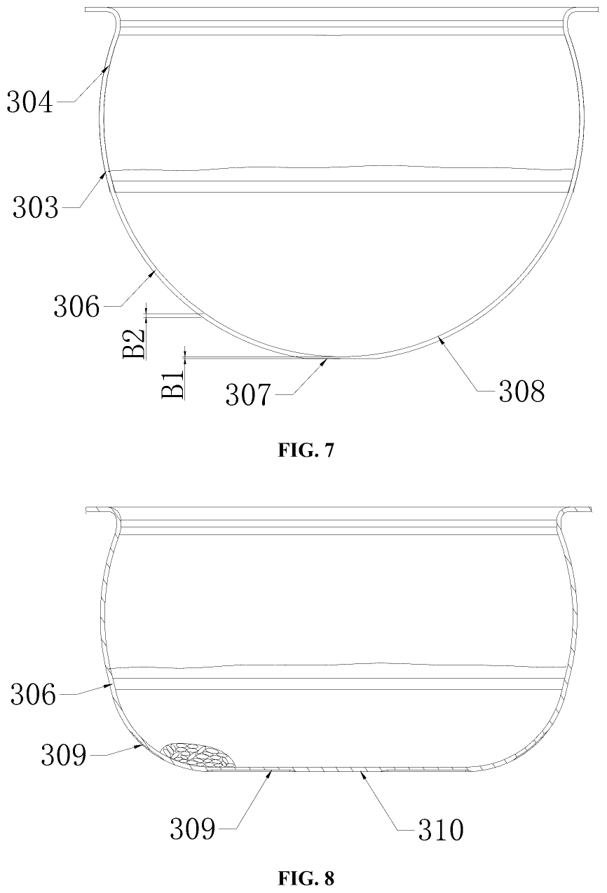

In some embodiments, as shown in FIG. 7, an outer side wall of the lower portion 302 has a curved side wall 306 and a flat bottom wall 307. A portion of an inner side wall of the lower portion 302 in correspondence to the curved side wall and the flat bottom wall is a spherical inner wall 308. With the spherical inner wall 308, a surface area of the lower portion 302 contacting the rice is minimized, and the cooling time is minimized. The curved side wall 306 refers to a curved shape of a section of the outer side wall of the inner cooking container along the vertical direction. The curved side wall 306 rotating with respect to an axis can form a curved surface. The curved shape may have a varied curvature instead of a constant curvature, which means that the curved surface of the lower portion 302 may not be a spherical surface. With the flat bottom wall 307, the inner cooking container can be put on the table in a flat manner. The flat bottom wall 307 means that the corresponding outer side wall of the inner cooking container is provided horizontally. The outer side wall is flat and the inner side wall is curved, and using experience of the inner cooking container is ensured. A contact surface area between the rice and the inner cooking container is minimized due to the spherical inner wall 308 given an amount of rice. Therefore, the energy released by the water vapor when condensing is decreased, to reduce the cooling time.

Further, in some embodiments, as shown in FIG. 7, a wall thickness between the spherical inner wall 308 and the flat bottom wall 307 is B1, and a wall thickness between the spherical inner wall 308 and the curved side wall 306 is B2, where B1≤B2. The B1 and the B2 may be a minimal thickness or an average thickness. In general, the thickness of the wall of the inner cooking container ranges from 0.5 mm to 10 mm, which is designed according to actual situations. When B1≤B2, the inner cooking container having the flat outer side wall and the curved inner side wall can be as light as possible, and the weight of the inner cooking container is reduced, and the heat storage capacity of the inner cooking container can be reduced, to facilitate cooling of the inner cooking container, which makes the condensed water form faster.

To facilitate processing, the inner cooking container is usually shaped by stamping. In this way; the inner cooking container has a constant thickness, and the outer wall and the inner wall have the same shape. In this case, in some embodiments, as shown in FIG. 8, the lower portion 302 is provided with a flat bottom portion 310, and an inner wall and an outer wall of the flat bottom portion 310 are both arranged horizontally. A surface area of the inner wall of the flat bottom portion 310 is smaller than a surface area of the outer wall of the flat bottom portion 310. To make the surface area of the inner wall smaller than the surface area of the outer wall, the outer side wall of the inner cooking container lower portion 302 is provided with a groove 309 or a protrusion. The groove 309 or the protrusion on the outer wall of the flat bottom portion 310 increases the surface area of the outer wall of the flat bottom portion 310, to increase the temperature increase of the cool air and further increasing the heat taken away by the cool air per minute, hence the cooling time is reduced.

In some embodiments, the curved side wall 306 or the flat bottom wall 307 may be provided with a groove 309 or a protrusion to increase the surface area of the outer side of the inner cooking container lower portion 302. In this way, the difference between surface areas of the inner side wall and the outer side wall of the inner cooking container having the flat outer side wall and the curved inner side wall is further increased, and the part contacting the rice has a large surface area outside and a small surface area inside, which accelerates the forming of the condensed water.

Improvement of the cooling performance may be achieved by adjustment to the flow rate of the cool air. Suppose a rated flow rate of the cooling fan 40 is 200 L/min. Due to the air resistance of the air channel, the actual flow rate suffers a loss and decreases below 200 L/min as a result. Therefore, the flow rate can be increased by reducing of the air resistance, to reduce the cooling time.

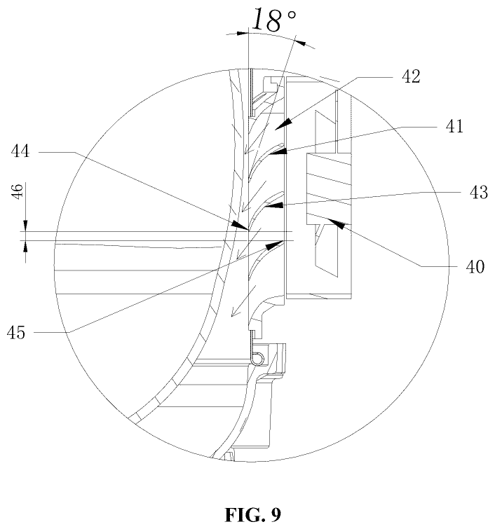

As shown in FIG. 9, an air guide blade 41 and an air guide channel 42 are provided at the air inlet 108. With the air guide blade 41, the cool air enters into the thermal insulation gap 107 from the air inlet 108 along an air intake angle. In one embodiment, the air intake angle of the air through the air guide blade 41 ranges from 10 degrees to 20 degrees. The air intake angle is an angle between a tangent direction of the air guide blade 41 at the air inlet 108 and a vertical direction of the thermal insulation inner cover 101. In the present embodiment, the air intake angle is 18 degrees. In some variations of the present embodiment, the air intake angle may be 10 degrees, 12 degrees, 15 degrees, 20 degrees or the like. If the air intake angle is smaller than 10 degrees, molding and processing of the air guide channel 42 may be difficult. If the air intake angle is larger than 20 degrees, the cool air may act more on the wall of the inner cooking container, causing a higher air resistance.

The air guide blade 41 has an air guide face 43 extending from the cooling fan 40 side to the thermal insulation gap 107 side in a curved manner. In this way, when flowing through the air guide blade 41, cool air from the cooling fan 40 turns from a horizontal direction to the preset air intake angle smoothly to enter the thermal insulation gap 107, which prevents air flow loss due to unreasonable design of the air guide blade 41. Furthermore, the air resistance of the air guide blade 41 can be reduced, to increase the air flow rate and improving the cooling efficiency.

Projections of an upper air guide blade 44 and a lower air guide blade 45 forming the air guide channel 42 along the horizontal direction do not overlap. For example, an air guide gap 46 is provided between a lower end portion of the upper air guide blade 44 and an upper end portion of the lower air guide blade 45. The air guide gap 46 facilitates molding of the air guide blade 41 and reduces the air resistance of the air guide channel 42.

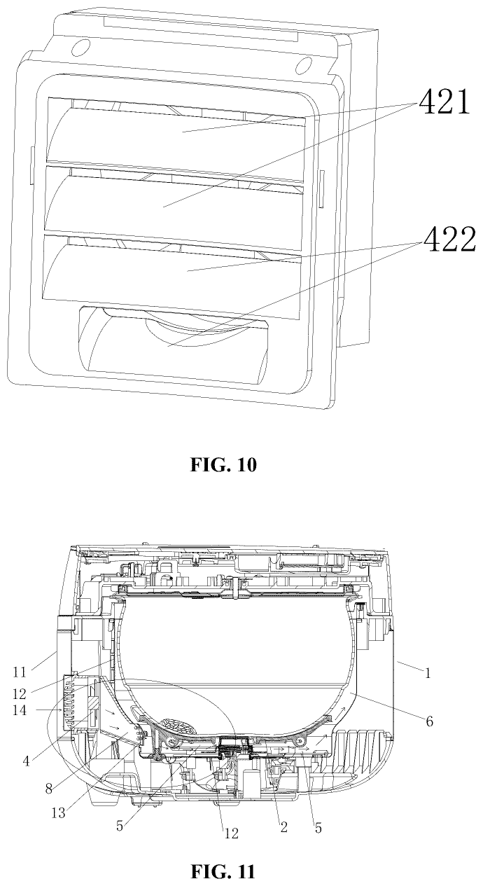

As shown in FIG. 10, the air guide channel 42 includes a first air guide channel 421 and a second air guide channel 422, through which the cool air is supplied to the side wall of the inner cooking container 30 and the thermal insulation gap 107 respectively. Each air guide channel 42 is located at a height where the curved side wall 306 of the lower portion 302 is located. The first air guide channel 421 is located at a position where the lower portion 302 has a maximal diameter. The air intake angle of the first air guide channel 421 intersects the curved side wall 306, and the cool air can be supplied to the waist portion 303 through the first air guide channel 421. The diameter of the side wall of the inner cooking container is large at the waist portion, hence the surface area is large. The cool air supplied to this position by a part of the air guide channel easily converges to ensure even cooling of the lower portion 302. The air intake angle of the second air guide channel 422 do not intersect the curved side wall 306, and the cool air through the second air guide channel 422 can be supplied to the thermal insulation gap 107 rather than the wall of the inner cooking container. In this way, the air resistance is reduced, and the flow rate of the cool air is increased, to reduce the cooling time. Multiple first air guide channels 421 and multiple second air guide channels 422 are provided. In the present embodiment, two first air guide channels 421 and two second air guide channels 422 are provided.

The cooling fan 40 is arranged at a corner of the outer housing 102. The inner cavity 114 between the outer housing 102 and the thermal insulation inner cover 101 has a largest space at the corner, which facilitates the air suction of the cooling fan 40 and reduces the air resistance, to increase the air flow rate.

### Second Embodiment

An easy-to-clean rice cooker is provided according to the present embodiment. Referring to FIGS. 11 to 13, the rice cooker includes a cooker body 1, a heating plate 2, an inner cooking container 3 and a cooling fan 4 that are arranged inside the cooker body 1. The heating plate 2 heats the inner cooking container 3, and a first gap 5 is provided between the heating plate 2 and an inner wall of the cooker body. A second gap 6 is provided between a side wall of the inner cooking container and the inner wall of the cooker body. The first gap 5 is in communication with the second gap 6. The inner wall of the cooker body 1 is provided with a cooling air inlet 13, and the cooling air inlet 13 at least faces the first gap 5. Cool air blown by the cooling fan 4 through the cooling air inlet flows from the first gap 5 to the second gap 6.

Food ingredients are put inside the inner cooking container 3. The heating plate 2 contacts the inner cooking container 3 to conduct heat to the inner cooking container 3. In the prior art, the side wall of the inner cooking container 3 is generally cooled in order to cool the inner cooking container 3. However, for a rice cooker heated by the heating plate 2, since the heating plate has a high thermal inertia, the heating plate 2 still conducts heat to the inner cooking container 3 even if the side wall of the inner cooking container 3 is cooled, resulting in a poor cooling performance, besides that the ingredients mainly gather at the bottom of the inner cooking container 3. With a ventilation gap according to the present application, the heat source, i.e. the heating plate 2, can be cooled, to achieve an optimal cooling performance. Further, the bottom of the inner cooking container can be cooled, which prevents rice at the bottom of the inner cooking container from browning and sticking to the inner cooking container. After the rice in the inner cooking container is cooked, the cooling fan cools the bottom portion of the inner cooking container, to decrease the temperature of the inner cooking container. Therefore, water vapor condenses on the inner wall of the inner cooking container to form the condensed water, which forms an isolation layer between the inner wall of the inner cooking container and the rice to prevent the rice from sticking to the inner cooking container, and the rice can be scooped by a spoon along the inner wall of the inner cooking container. Although there are structures that cools the heating plate in the prior art, a cooling medium is usually provided under the heating plate, which has high cost and needs complicated manufacturing process. In the present application, the heating plate 2 is cooled and the cooling effect of the inner cooking container can be realized just by the cooling fan 4 in cooperation with the ventilation gap. Cooling air blown by the cooling fan 4 through the cooling air inlet 13 first enters the first gap 5 to cool the heating plate 2 directly and effectively; and then enters the second gap 6 to cool the side wall of the inner cooking container 3 to form stable circulation, to realize ideal cooling performance with low cost and a long service life.

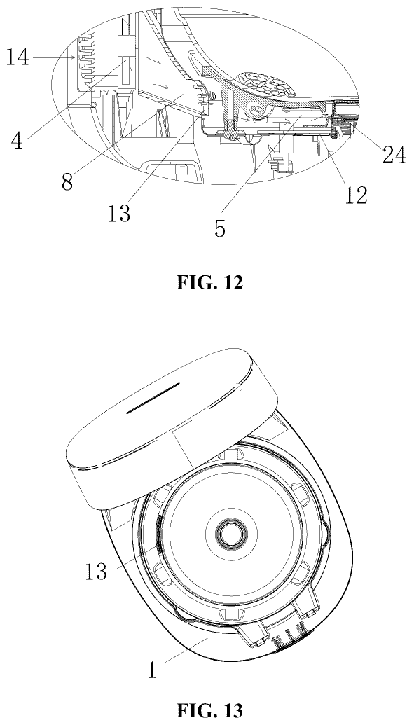

Further, referring to FIG. 11 and FIG. 12, the cooker body 1 includes a housing 11 and a thermal insulation cover 12 located inside the housing 11. The heating plate 2 and the inner cooking container 3 are located inside the thermal insulation cover 12. The heating plate 2 heats the inner cooking container 3, and the first gap 5 is provided between the heating plate 2 and a bottom wall of the thermal insulation cover 12, and the second gap 6 is provided between the side wall of the inner cooking container 3 and a side wall of the thermal insulation cover 12. The first gap 5 is in communication with the second gap 6. The inner wall of the cooker body 1 is provided with the cooling air inlet 13, and the cooling air inlet 13 at least faces the first gap 5. Cooling air blown by the cooling fan 4 through the cooling air inlet 13 flows from the first gap 5 to the second gap 6. The bottom wall of the thermal insulation cover 12 is provided with an air outlet, and a heat dissipation space is formed between the thermal insulation cover 12 and the housing 11. Hot air can be discharged in time through the air outlet, and the temperature inside the thermal insulation cover 12 is decreased to prevent a case that the cooling air circulates inside the thermal insulation cover 12 but is not able to take the hot air away, which otherwise affects the cooling performance.

In the present embodiment, referring to FIG. 12, the cooling fan 4 is located outside the thermal insulation cover 12. An inner wall of the thermal insulation cover 12 is provided with the cooling air inlet 13. A height of the cooling air inlet 13 is lower than a height of the heating plate 2, and the cooling air blown by the cooling fan through the cooling air inlet flows toward the heating plate 2. The thermal insulation cover 12 is generally made of metals, to prevent overtemperature of the housing of the rice cooker due to heat transfer from the heating plate 2 and the inner cooking container 3 to outside of the thermal insulation cover 12. Furthermore, the thermal insulation cover 12 can also reduce the heat loss of the heating plate 2 when heating. The cooling fan 4 is located outside the thermal insulation cover 12, and the heating plate 2 is provided inside the thermal insulation cover 12. In this way, the heat of the heating plate 2 cannot be radiated to the cooling fan, to increase the service life of the cooling fan. In one embodiment, the cooling fan 4 may not occupy a space inside the thermal insulation cover 12, which has a limited space. The cooling fan 4 is located outside the thermal insulation cover 12 and is closer to the exterior, thus can easily suck cool air from the exterior to the thermal insulation cover 12. In the present embodiment, the height of the cooling air inlet 13 is lower than the height of the heating plate 2, and the cooling air from the cooling air inlet 13 can blow towards the heating plate 2 instead of towards the inner cooking container 3, to cool the heat source, i.e. the heating plate 2.

In the present embodiment, referring to FIG. 11, the housing 11 is provided with an air intake 14. The cooling fan 4 is located between the air intake 14 and the cooling air inlet 13 to suck cooling air outside the housing 11 from the air intake 14, and blow the cooling air through the cooling air inlet 13. With the air intake 14 on the housing 11, the cooling fan 4 can directly suck a lot of cooling air from the exterior, and blow the air into the thermal insulation cover 12 to cool the heating plate 2. In the present embodiment, the air intake 14 is located at a side wall of the housing 11. In other embodiments, the air intake 14 may be located at a bottom wall of the housing 11.

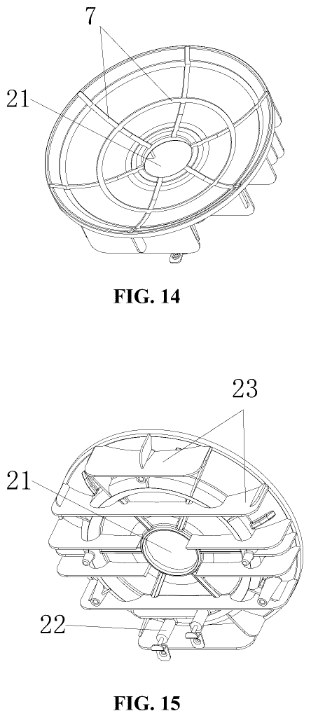

In the present embodiment, referring to FIG. 14 and FIG. 15, a groove or a protrusion is provided at a portion of the heating plate 2, and a ventilation gap 7 is provided between the inner cooking container 3 and the heating plate 2. For the structure where the heating plate 2 heats the inner cooking container 3, stopping the heat transfer from the heating plate 2 to the inner cooking container 3 is the key to cool the inner cooking container 3. In the present embodiment, the groove or the protrusion is provided at the portion of the heating plate 2, and the ventilation gap is formed between the inner cooking container 3 and the heating plate 2. The cooling air is blown into the ventilation gap for cooling, to decrease the temperature of the inner cooking container rapidly. In one embodiment, the ventilation gap 7 includes a circumferential gap 71 and a radial gap 72 that are arranged in a staggered manner. With these staggered gaps, the cooling air can be spread quickly for cooling.

In the present embodiment, referring to FIG. 12, FIG. 14 and FIG. 15, a through hole 21 is provided at a center of the heating plate 2. An air deflector 24 is provided at the through hole 21, and the air deflector 24 guides at least a part of the cooling air to flow from the first gap 5 to the ventilation gap 7. With the through hole 21 and the air deflector 24 on the heating plate 2, the cooling air can flow from the first gap 5 to the ventilation gap 7. The cooling air can cool a bottom portion of the heating plate 2 when flowing through the first gap 5, and can cool a top portion of the heating plate 2 after being guided to the ventilation gap 7 by the air deflector 24 and spreading to other areas of the heating plate 2. In this way, both the top portion and the bottom portion of the heating plate 2 are cooled. In one embodiment, the cooling air flowing from the first gap 5 is just blown from the cooling air inlet 13, thus has a relatively low temperature. Therefore, the cooling air can cool the bottom portion and the top portion of the heating plate 2 immediately after entering the thermal insulation cover 12, to achieve an optimal cooling performance. In the present embodiment, with the air deflector 24 and the ventilation gap 7, the cooling problem in the case that the heating plate contacts the inner cooking container is solved.

In the present embodiment, referring to FIG. 15, the bottom portion of the heating plate 2 is provided with multiple ribs 23 to ensure smooth circulation of the cooling air from the first gap 5. The multiple ribs 23 form multiple air guide channels. The multiple ribs are provided in parallel. The cooling air inlet 13 is provided facing the multiple air guide channels, and the multiple air guide channels enable the cooling air to circulate smoothly. In conjunction with FIG. 12, a part of the cooling air cooperates with the air deflector 24, passes through the through hole 21 and reaches above the heating plate 2, and spreads to other areas of the heating plate 2 via the ventilation gap 7.

In the present embodiment, referring to FIG. 12, an air channel 8 is provided between the cooling fan 4 and the cooling air inlet 13, and a cross-sectional area of the air channel 8 decreases gradually. When the rotation speed of the cooling fan 4 keeps constant, the air channel with a decreasing cross-sectional area can accelerate the circulation of the cooling air, which improves the cooling performance of the cooling fan 4.

In the present embodiment, referring to FIG. 12, the second gap 6 gradually narrows down from bottom to top. With this design, most of the cooling air stays under the inner cooking container 3, while the rice stays at the bottom of the inner cooking container 3 as well during cooking. Therefore, a region of the inner cooking container where the rice stays can be effectively cooled.

In the present embodiment, the inner cooking container is spherical. The spherical inner cooking container has the largest circle of latitude, and the cooling fan is arranged below the largest circle of latitude. The largest circle of latitude is a feature of the spherical inner cooking container. That is, there is a position along a height direction where the width is largest. Starting from the largest circle of latitude, the width gradually decreases upwards or downwards. In the present embodiment, the cooling fan is arranged below the largest circle of latitude. Due to the shape of the spherical inner cooking container, a space in a horizontal direction at the largest circle of latitude is smallest, while there are some spaces above or below the largest circle of latitude. In one embodiment, the space below the inner cooking container needs more cooling. Therefore, considering the available space and the cooling performance, the cooling fan is arranged below the largest circle of latitude according to the present application.

In the present embodiment, the inner cooking container 3 is made of stainless steels. In the prior art, an inner surface of the inner cooking container 3 is provided with a non-stick coating to prevent the rice from sticking. The non-stick coating is not durable under scratching or scraping, and may peel off after a long time. As a result, the rice may stick to the inner cooking container 3, and a service life of the inner cooking container 3 is decreased. In the present embodiment, after the rice in the inner cooking container is cooked, the cooling fan cools the bottom portion of the inner cooking container, to decrease the temperature of the inner cooking container. Therefore, water vapor condenses on the inner wall of the inner cooking container to form the condensed water, which forms an isolation layer between the inner wall of the inner cooking container and the rice and further prevent the rice from sticking to the pot, and thus the rice can be scooped by a spoon along the inner wall of the inner cooking container. According to the present embodiment, since the rice is prevented from sticking to the pot by the cooling fan, the inner cooking container can be made of stainless steels and the non-stick coating is not needed on the inner surface of the inner cooking container, to greatly increase the service life of the inner cooking container 3. Without the non-stick coating on the inner surface, there is no need to worry about the coating peeling off, and stainless steel scrubbers can be used for cleaning the inner surface of the inner cooking container.

In the present embodiment, a terminal 22 of the heating plate 2 passes through the bottom wall of the insulation cover 12 and extends into the heat dissipation space. The terminal 22 is located under the insulation cover 12, where the temperature is relatively low. In this way, the service life of the electric elements is increased. In one embodiment, airflow discharged from the air outlet can further cool the terminal 22. The air outlet may be formed by a through hole on the bottom wall of the insulation cover 12. Multiple air outlets may be provided, where electric elements such as the terminal 22 pass through a part of the air outlets, and temperature measurement elements pass through another part of the air outlets at the same time.

Parts not described in the present application can be realized by adopting or referring to the prior art.

The above embodiments in this specification are described in a progressive manner, and references may be made among these embodiments with respect to the same or similar portions among these embodiments. Each of the embodiments is mainly focused on describing its differences from other embodiments.

The embodiments described hereinabove are only examples of the present application, and are not intended to limit the present application. Many modifications and variations may be made to the present application. Any modifications, equivalent substitutions and improvements made to the present application without departing from the embodiments of the present application are deemed to fall into the scope of the claims of the present application.

1. An easy-to-clean rice cooker, comprising:
a cooker body;
a cooker lid;
an inner cooking container for cooking rice;
a heating device; and
a cooling fan, wherein the cooker body is provided with an accommodation chamber, and the inner cooking container is arranged inside the accommodation chamber and is located above the heating device;
when the cooker lid is closed, the accommodation chamber is enclosed and a cooking chamber is formed by the cooker lid and the inner cooking container;
the cooling fan is configured to cool the inner cooking container, and when a part of a lower portion of the inner cooking container that contacts the rice is cooled and a temperature of the part is decreased, condensed water is formed at the part and wets the rice contacting an inner wall of the inner cooking container;
a first air outlet is provided at a position where the cooker lid and the cooker body are combined, a combination gap is provided between the cooker lid and the cooker body, and the combination gap forms the first air outlet; and
cool air is discharged through the first air outlet after cooling the inner cooking container.

2. The easy-to-clean rice cooker according to claim 1, wherein
the inner cooking container is provided with a flange, and an air outlet channel is provided at a position where the flange matches the cooker body; and
the cooker body comprises an thermal insulation inner cover, an thermal insulation gap is provided between an outer side wall of the inner cooking container and an inner wall of the thermal insulation inner cover, and air in the thermal insulation gap enters the first air outlet through the air outlet channel.

3. The easy-to-clean rice cooker according to claim 1, wherein
the cooker body comprises an thermal insulation inner cover and a second air outlet, the second air outlet is in communication with an inner cavity between the thermal insulation inner cover and an outer housing, and a bottom portion of the cooker body is provided with a heat dissipation hole in communication with the inner cavity; and
the air is discharged into the inner cavity through the second air outlet after cooling the inner cooking container, and is discharged through the heat dissipation hole.

4. The easy-to-clean rice cooker according to claim 3, wherein the second air outlet is arranged at a side of the cooling fan, and the side refers to a position close to the cooling fan, and a distance between the position and the cooling fan is less than or equal to 10 cm.

5. The easy-to-clean rice cooker according to claim 3, wherein the second air outlet is arranged at a same height as the cooling fan.

6. The easy-to-clean rice cooker according to claim 2, wherein
the cooker body comprises a ring, and the ring is provided with a support member; and
the support member is provided at the position where the flange matches the cooker body, and the inner cooking container is supported by the support member to form the air outlet channel.

7. The easy-to-clean rice cooker according to claim 6, wherein a plurality of support members are provided, and the air outlet channel is formed between two adjacent support members.

8. The easy-to-clean rice cooker according to claim 1, wherein an outer side wall of the lower portion of the inner cooking container has a curved side wall and a flat bottom wall, and a part of an inner side wall of the lower portion of the inner cooking container in correspondence to the curved side wall and the flat bottom wall is a spherical inner wall.

9. The easy-to-clean rice cooker according to claim 1, wherein the lower portion of the inner cooking container has a flat bottom portion that runs through an inner side wall and an outer side wall of the lower portion of the inner cooking container, and a surface area of an inner wall of the flat bottom portion is smaller than a surface area of an outer wall of the flat bottom portion.

10. The easy-to-clean rice cooker according to claim 8, wherein a groove or a protrusion is provided on the outer side wall of the lower portion of the inner cooking container.

11. The easy-to-clean rice cooker according to claim 9, wherein a groove or a protrusion is provided on the outer side wall of the lower portion of the inner cooking container.
